(19) United States
(12) Patent Application Publication
(10) Pub. No.: US 2023/0393567 A1
(43) Pub. Date: Dec. 7, 2023

(54) CONSTRAINT OPERATOR FOR PROCESS MINING

(71) Applicant: UiPath, Inc., New York, NY (US)

(72) Inventors: Dennis BRONS, Eindhoven (NL); Theodor-Christian CHIRVASUTA, Eindhoven (NL); Roeland Johannus SCHEEPENS, Eindhoven (NL)

(73) Assignee: UiPath, Inc., New York, NY (US)

(21) Appl. No.: 17/805,486

(22) Filed: Jun. 6, 2022

(51) Int. Cl. G05B 19/418; G06K 9/62

(52) U.S. Cl. CPC G05B 19/41885; G06K 9/6277; G05B 17/02; G05B 2219/2609; G05B 2219/25011

(57) ABSTRACT

Systems and methods for annotating exclusive-or nodes or the exclusive outgoing paths of a process model of a process are provided. A process model representing execution of a process is received. Exclusive-or blocks in the process model are identified. Attribute data relating to an exclusive outgoing path from an exclusive-or node in each of the identified exclusive-or blocks are identified. At least one of the exclusive-or node or the exclusive outgoing paths are annotated based on the attribute data. The annotated at least one of the exclusive-or node or the exclusive outgoing paths are output.

### FIELD

The present invention generally relates to process mining of computer processes, and more specifically, to a constraint operator for the analysis of exclusive-or (XOR) nodes in process models of computer processes.

### BACKGROUND

Processes are sequences of activities executed by one or more computers to provide various services. The execution of a process may be represented as a process model, where each activity is represented as a node and execution between activities is represented as an edge linking nodes. In process mining, process models are evaluated in order to identify improvements to the execution of processes. Often times, process models may include exclusive-or (XOR) nodes. However, such process models do not provide any information on the execution of the paths from the XOR nodes, such as, e.g., information relating to when and why certain paths from the XOR nodes are executed. Conventionally, information on the execution of paths from XOR nodes in a process model is determined using a separate software tool. However, this conventional approach results in reduced efficiency and increased costs. Accordingly, an improved and/or alternative approach may be beneficial.

### SUMMARY

Certain embodiments of the present invention may provide alternatives or solutions to the problems and needs in the art that have not yet been fully identified, appreciated, or solved by current process mining technologies. For example, some embodiments of the present invention pertain to a constraint operator for the analysis of exclusive-or (XOR) nodes in process models of computer processes.

In accordance with one embodiment, a process model representing execution of a process is received. Exclusive-or blocks in the process model are identified. Attribute data relating to an exclusive outgoing path from an exclusive-or node in each of the identified exclusive-or blocks are identified. At least one of the exclusive-or node or the exclusive outgoing paths are annotated based on the attribute data. The annotated at least one of the exclusive-or node or the exclusive outgoing paths are output.

In one embodiment, the attribute data comprises numerical statistics comprising one or more a mean, a median, a number of quantiles, or a probability density function for an attribute. In another embodiment, the attribute data comprises categorical statistics comprising one or more of a mode or a probability mass function.

In one embodiment, a decision tree for one or more of the attributes is generated. The decision tree denotes a threshold value to split paths. User input selecting the exclusive-or node or the exclusive outgoing paths may be received. In response to receiving the user input, the attribute data may be displayed.

In one embodiment, the process is executed using one or more computing devices. In one embodiment, the process is a robotic process automation (RPA) process executed by one or more RPA robots.

### BRIEF DESCRIPTION OF THE DRAWINGS

In order that the advantages of certain embodiments of the invention will be readily understood, a more particular description of the invention briefly described above will be rendered by reference to specific embodiments that are illustrated in the appended drawings. While it should be understood that these drawings depict only typical embodiments of the invention and are not therefore to be considered to be limiting of its scope, the invention will be described and explained with additional specificity and detail through the use of the accompanying drawings, in which:

FIG. 1 shows a method for annotating exclusive-or nodes and/or exclusive paths of a process model, in accordance with one or more embodiments.

FIG. 2 shows an illustrative process model representing execution of a process, in accordance with one or more embodiments.

FIG. 3 shows an exemplary event log of execution of a process, in accordance with one or more embodiments.

FIG. 4 shows an exemplary exclusive-or (XOR) block of a process model, in accordance with one or more embodiments.

FIG. 5 shows an exemplary user interface visualizing a process model, in accordance with one or more embodiments.

FIG. 6 shows an exemplary user interface visualizing a process model, in accordance with one or more embodiments.

FIG. 7 shows an exemplary user interface visualizing a dashboard, in accordance with one or more embodiments.

FIG. 8 shows an exemplary user interface, in accordance with one or more embodiments.

FIG. 9 shows an exemplary decision tree generated in accordance with one or more embodiments.

FIG. 10 is an architectural diagram illustrating a computing system configured to perform embodiments described herein.

Unless otherwise indicated, similar reference characters denote corresponding features consistently throughout the attached drawings.

### DETAILED DESCRIPTION OF THE EMBODIMENTS

A computer process may be executed by one or more computing devices to provide services for a number of different applications, such as, e.g., administrative applications (e.g., onboarding a new employee), procure-to-pay applications (e.g., purchasing, invoice management, and facilitating payment), and information technology applications (e.g., ticketing systems). In one embodiment, the process may be an RPA (robotic process automation) process automatically executed by one or more RPA robots.

In process mining, a process model representing execution of the process is evaluated in order to identify improvements to the execution of the process. In accordance with embodiments described herein, a constraint operator is provided for the analysis of exclusive-or (XOR) nodes in process models of computer processes. The constraint operator annotates exclusive-or nodes and/or exclusive paths with information relating to the XOR nodes in the process models, such as, e.g., information relating to when and why certain paths from the XOR nodes are executed. Advantageously, such annotation facilitates user evaluation of the process model, thereby increasing efficiency and decreasing costs as compared to conventional approaches.

It should be understood that while embodiments described herein are described for annotating exclusive-or nodes and/or exclusive paths outgoing from the exclusive-or nodes, embodiments described herein are not so limited. Embodiments described herein may be applied to annotate nodes and/or outgoing paths from such nodes defining any relationship operator, such as, e.g., parallel, looping, sequential, etc. and are not limited to exclusive-or relationships.

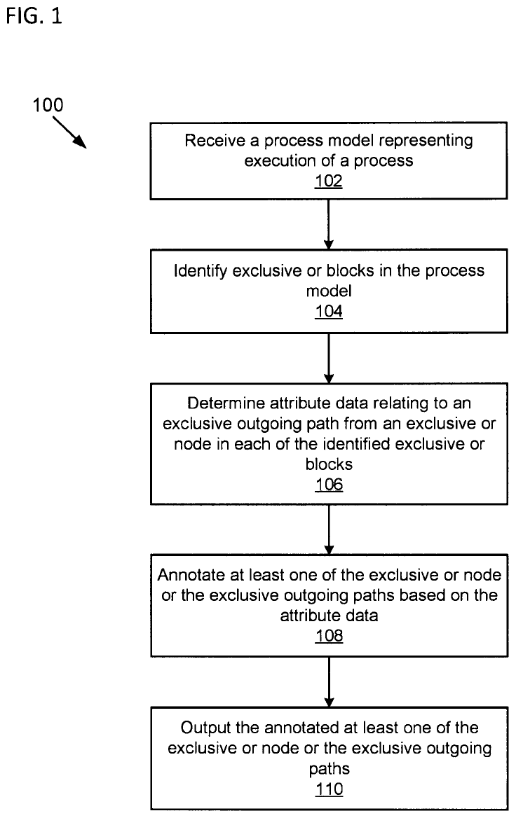

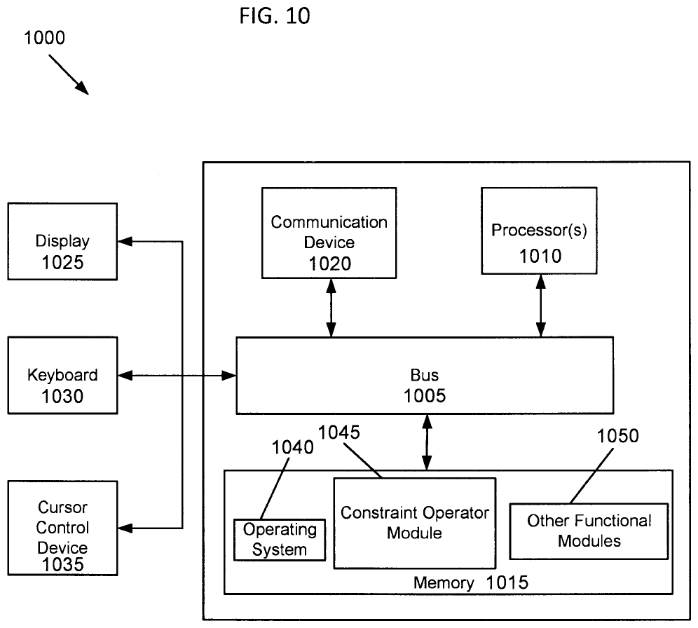

FIG. 1 shows a method 100 for annotating exclusive-or nodes and/or exclusive paths of a process model, in accordance with one or more embodiments. Method 100 may be performed by any suitable computing device or devices, such as, e.g., computing system 1000 of FIG. 10.

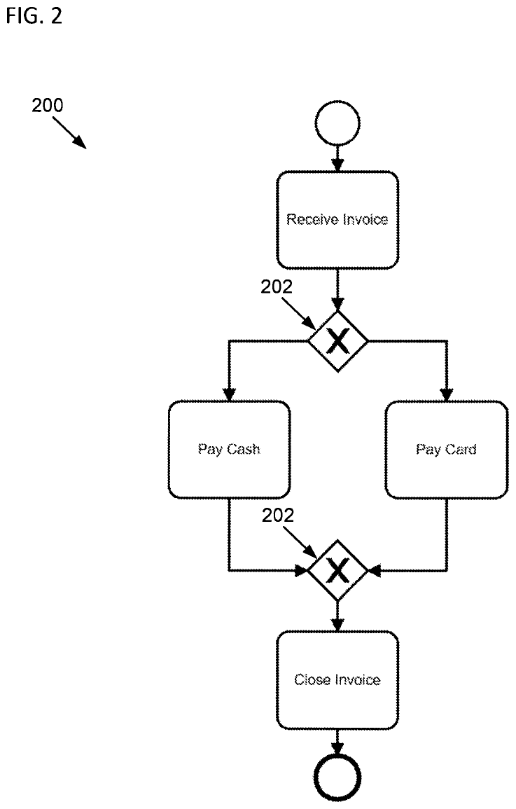

At step 102 of FIG. 1, a process model representing execution of a process is received. In one embodiment, the process model represents execution of an RPA process executed by one or more RPA robots. The process model may be received by, for example, loading the process model from a storage or memory of a computer system or receiving a process model that has been transmitted from a remote computer system. An illustrative process model is shown in FIG. 2.

FIG. 2 shows an illustrative process model 200 representing execution of a process, in accordance with one or more embodiments. Process model 200 is modelled as a directed graph where each activity of the process is represented as a node and the execution of the process from a source activity to a destination activity is represented as an edge connecting the nodes representing the source activity and the destination activity.

Process model 200 may comprise various gateway nodes, which are shown as diamond-shaped nodes in FIG. 2. Such gateway nodes typically represent various relationship or behavior operators in process model 200. In one embodiment, the gateway nodes of process graph 200 may comprise exclusive-or (also referred to as exclusive choice) nodes 202, shown in FIG. 2 as diamond-shaped nodes identified with an “X”. Process graph 200 may comprise other gateways nodes, such as, e.g., parallel nodes (shown in FIG. 2 as diamond-shaped nodes identified with a “+”) or looping nodes (shown in FIG. 1 as diamond-shaped nodes identified with a “ [symbol] ”). Other types of relationships are also contemplated, such as, e.g., sequential relationships.

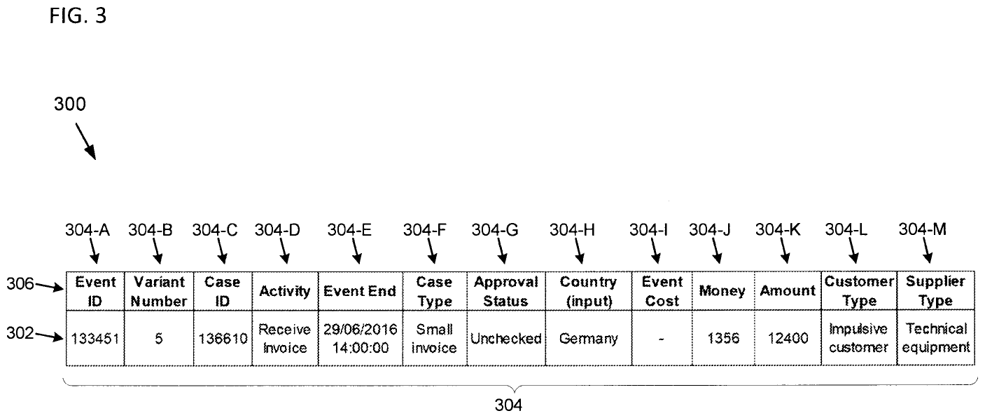

In one embodiment, process model 200 is generated using a probabilistic inductive miner, for example, as described in U.S. Patent Application Publication No. 2022/0075705, the disclosure of which is incorporated herein by reference in its entirety. However, process model 200 may be generated using any other suitable approach. Process model 200 is generated from an event log recording execution of the process. An illustrative event log is shown in FIG. 3.

FIG. 3 shows an exemplary event log 300 of execution of a process, in accordance with one or more embodiments. Event log 300 records events each corresponding to the execution of an activity of the process. As shown in FIG. 3, event log 300 is formatted as a table having one or more rows 302 each corresponding to a respective event and columns 304 each identifying an attribute of the respective event. The attributes of the event are identified in header row 306 and are defined with a value at a cell at which rows 302 and columns 304 intersect. In particular, each row 302 is associated with an event identifier (ID) of the respective event (identified in column 304-A), a variant number of the respective event (identified in column 304-B), a case ID identifying an instance of execution of the executed activity of the process for the respective event (identified in column 304-C), the executed activity of the process for the respective event (identified in column 304-D), an event end time of the respective event (identified in column 304-E), a case type of the respective event (identified in column 304-F), an approval status of the respective event (identified in column 304-G), a country (identified in column 304-H), an event cost of the respective event (identified in column 304-I), money associated with the respective event (identified in column 304-J), an amount associated with the respective event (identified in column 304-K), a customer type (identified in column 304-L), and a supplier type associated with the respective event (identified in column 304-M). It should be understood that event log 300 may be in any other suitable format and may include additional columns 304 or less columns 304 for identifying more or less attributes of events respectively.

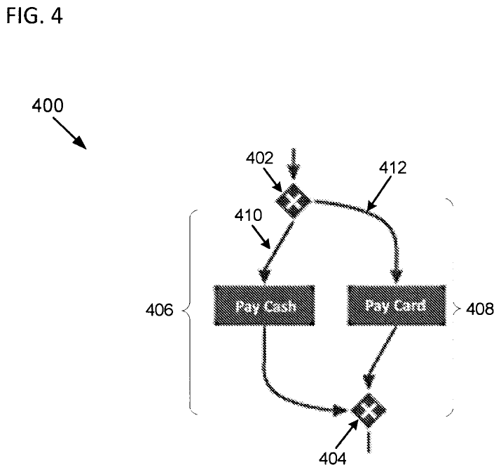

At step 104 of FIG. 1, exclusive-or blocks are identified in the process model. In one embodiment, the exclusive-or blocks may be identified using the helper function ExtractXORBlocks, which receives as input the process model and generates as output a list of exclusive-or blocks. An exemplary exclusive-or block is shown in FIG. 4.

FIG. 4 shows an exemplary exclusive-or block 400 of a process model, in accordance with one or more embodiments. Exclusive-or block 400 comprises a beginning exclusive-or node 402 and an ending exclusive-or node 404, with exclusive paths 406 and 408 therebetween. During each instance of execution of the process, only one of exclusive paths 406 or 408 is traversed between beginning exclusive-or node 402 and ending exclusive-or node 404 of the exclusive-or block 400. In one embodiment, identifying the exclusive-or blocks comprises identifying the beginning exclusive-or node 402, the ending exclusive-or node 404, outgoing edges 410 and 412 from the beginning exclusive-or node, and a list of event names of the exclusive path 406 and 408 started by each respective outgoing edge 410 and 412.

At step 106 of FIG. 1, attribute data relating to an exclusive outgoing path from an exclusive-or node in each of the identified exclusive-or blocks is determined. In one embodiment, the attribute data is determined by observing variations corresponding to the exclusive outgoing path in the event log. Each variation of the event log has multiple cases, where each case has multiple events, where each event has multiple attributes, and each attribute has a value. As such, each exclusive outgoing path corresponds to a range of attribute values which are extracted from the event log.

The attribute data may comprise any data relating to an exclusive outgoing path from an exclusive-or node in an exclusive-or block. In one embodiment, the attribute data may comprise numerical statistics, for example, represented as a list of numbers associated with one or more attributes and statistical measures of the list of numbers for each of the attributes, such as, e.g., mean, median, number of quantiles, probability density function mapping a quantile to a percentage of entries that are part of the quantile out of all entries. In another embodiment, the attribute data may comprise categorical statistics, for example, represented as a list of categorical data entries associated with one or more attributes and statistical measures of the list of categorical data for each of the attributes, such as, e.g., mode, probability mass function mapping each possible entry to the percentage of entries with that value out of all the entries.

In one embodiment, prior to determining the attribute data, each exclusive-or block is evaluated to identify skip locations in the exclusive outgoing path. A skip is an exclusive-or block, where one of the paths from the beginning exclusive-or node to the ending exclusive-or node does not contain any nodes, and hence nothing is done if that path is chosen. In effect, all other paths are “skipped”. In addition, given the skip locations, activities of other exclusive outgoing paths of the exclusive-or block are identified. In one embodiment, the skip locations are identified using a helper function FindAllSkips, which receives as input the process model and the exclusive-or nodes and generates as output a list of node IDs, and the activities of the other exclusive outgoing paths are identified using a helper function ExtractEventsToBeExcluded, which receives as input the skip locations and generates as output a list of event names to be excluded. The skip locations and the activities of the other exclusive outgoing paths are not considered at step 106, for example, by updating the mapping between exclusive paths and activities to be considered. If a skip needs to be handled, then the data attributes for the skip are related to events from the process model that are not part of traces that include the events from the other exclusive outgoing paths. To correlate attribute data to that skip, the event attribute data of traces that do not contain the events of any of the other exclusive outgoing paths in the block are used.

At step 108 of FIG. 1, at least one of the exclusive-or node or the exclusive outgoing paths are annotated based on the attribute data. In one embodiment, the annotations comprise the numerical statistics and/or the categorical statistics.

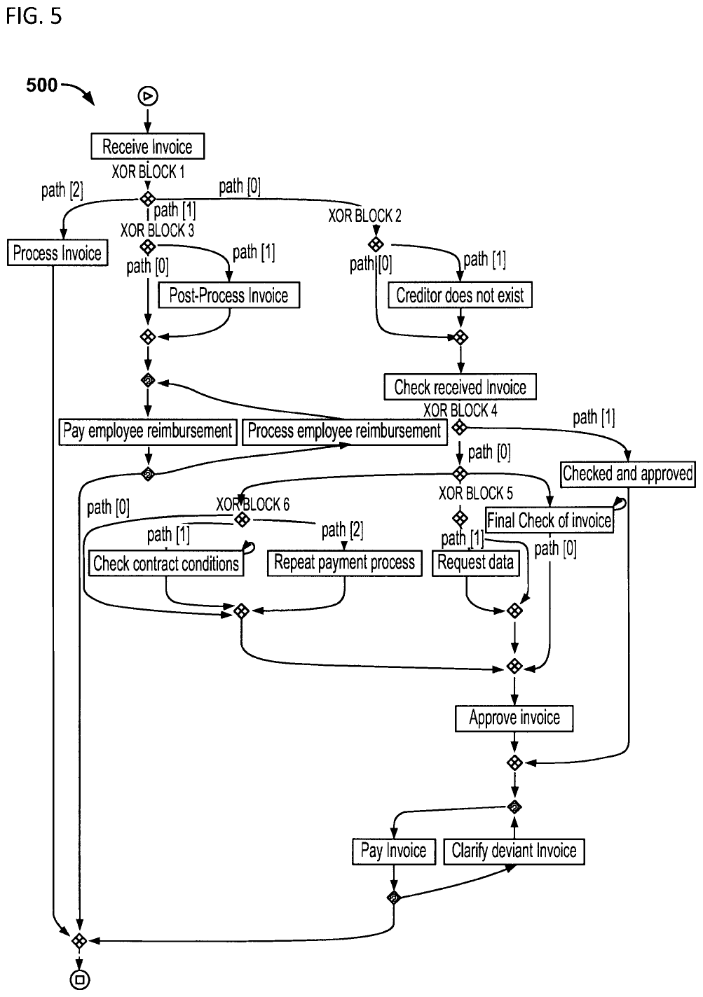

At step 110 of FIG. 1, the annotated at least one of the exclusive-or node or the exclusive outgoing paths are output. The annotated exclusive-or node or the exclusive outgoing paths may be output, for example, with the process model or with the exclusive-or blocks. In one embodiment, the annotated exclusive-or node or the exclusive outgoing paths may be output by, for example, displaying the annotated exclusive-or node or the exclusive outgoing paths on a display device of a computer system, storing the annotated exclusive-or node or the exclusive outgoing paths on a memory or storage of a computer system, or by transmitting the annotated exclusive-or node or the exclusive outgoing paths to a remote computer system. In some embodiments, the annotated exclusive-or node or the exclusive outgoing paths may be output as shown in FIGS. 5-8.

FIG. 5 shows an exemplary user interface visualizing a process model 500, in accordance with one or more embodiments. Exclusive-or blocks and exclusive outgoing paths are annotated in process model 500 to identify exclusive-or blocks and exclusive paths.

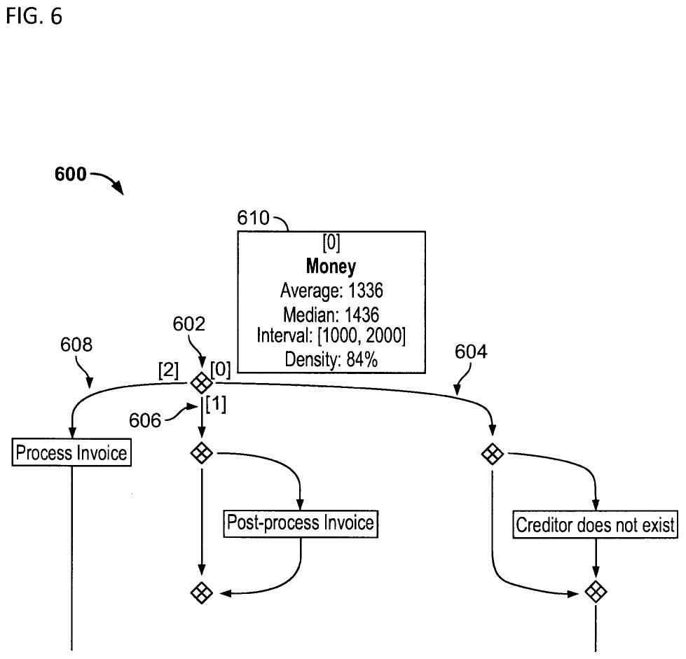

FIG. 6 shows an exemplary user interface visualizing a process model 600, in accordance with one or more embodiments. Process model 600 comprises a beginning exclusive-or node 602 with exclusive outgoing path [0] 604, exclusive outgoing path [1] 606, and exclusive outgoing path [2] 608. A user may interact with process model 600 by, e.g., hovering or otherwise selecting a mouse cursor over exclusive outgoing path [0] 604 to show window 610. Window 610 shows a subset of statistics for exclusive outgoing path [0] 604 for the attribute money. The subset of statistics comprises an average of 1336, a median of 1436, and interval of [1000, 2000], and a density of 88%.

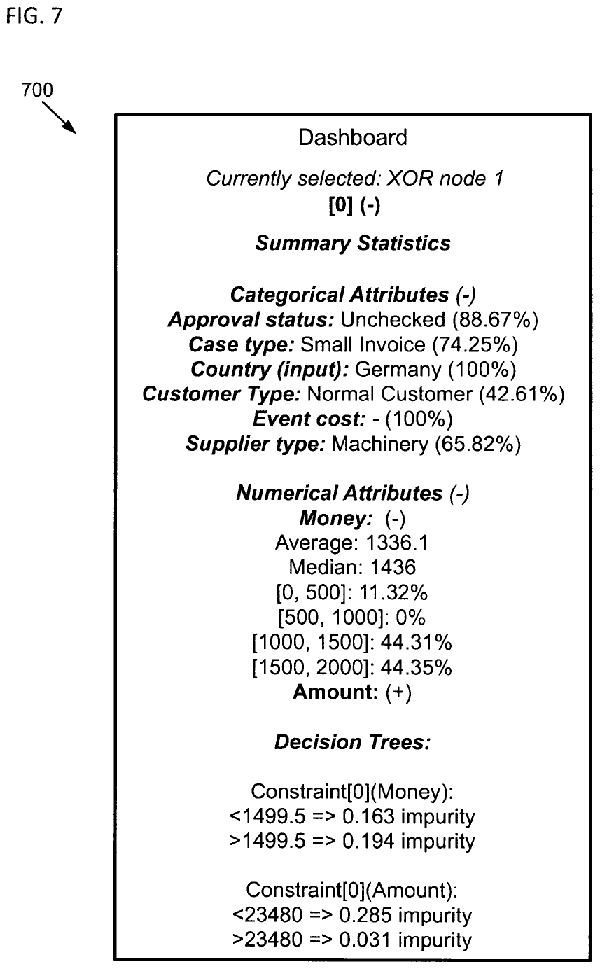

FIG. 7 shows an exemplary user interface visualizing a dashboard 700, in accordance with one or more embodiments. Dashboard 700 allows a user to perform a drill down analysis on a selected exclusive-or node. A user may interact with a process model to select the exclusive-or node to show dashboard 700. Dashboard 700 shows a summary of statistics and decision trees for the selected exclusive-or node. The statistics comprises categorical statistics for approval status, case type, country, customer type, event cost, and supplier type. The statistics also comprise numerical statistics for average, median, and intervals [0, 500], [500, 1000], and [1500, 2000] for the attribute money. The decision trees are generated for the attributes money and amount with split values of 1499.5 and 23480 respectively.

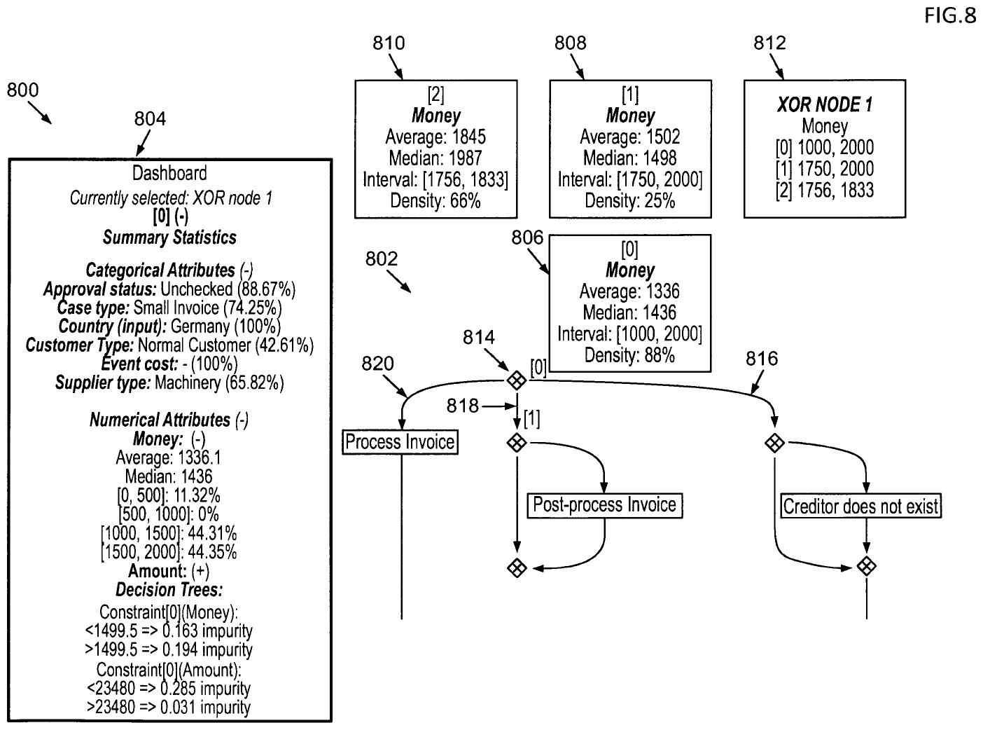

FIG. 8 shows an exemplary user interface 800, in accordance with one or more embodiments. User interface 800 shows process model 802. A user may interact with process model 802 to view various information relating to exclusive-or nodes in process model 802. As shown in user interface 800, a user may select exclusive-or node 814 to show dashboard 804 and windows 806-812. Dashboard 804 shows a summary of statistics and decision trees for exclusive-or node 814. Windows 806, 808, and 810 show numerical statistics for the attribute money for exclusive outgoing paths 816, 818, and 820 respectively. Window 812 shows intervals for the attribute money for exclusive outgoing paths 816, 818, and 820 outgoing from exclusive-or node 814.

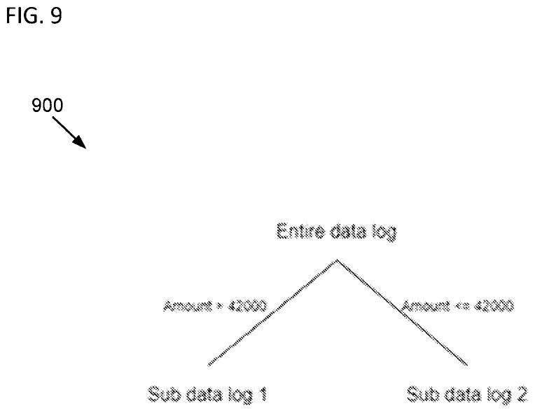

In one embodiment, decision trees are generated denoting, for each respective attribute, 1) the best numerical value on which to split and 2) the paths most often traversed if looking only at the values of the respective attribute. The decision trees may be generated based on the aggregated numerical attribute values corresponding to the paths of the exclusive-or node. Based on the distribution of the values of the numerical attribute data, split points are identified, creating value ranges. These value ranges are then correlated with the exclusive-or node paths whose attribute values most closely adhere to the split ranges. In one embodiment, the best numerical threshold value is determined using a helper function ApplyAllFilters, which receives as input the list of exclusive-or blocks and generates as output two dictionaries indexed by the attribute name, one for the categorical attributes and one for the numerical attributes. FIG. 9 shows an exemplary decision tree 900 generated in accordance with one or more embodiments. Decision tree 900 differentiates log data based on a threshold value of 42000.

In one embodiment, the decision trees can be extended to have a depth larger than 1, which results in increasing the visual complexity. This can lead to obtaining decisive and robust constraints that are based on multiple dimensions at the same time.

In one embodiment, the number of data structures used may be decreased from two (one for numerical statistics and one or categorical statistics) to one by introducing a generic data type.

In one embodiment, the constraint operator can represent the intervals on which exclusive paths overlap and present a probabilistic representation of the number of occurrences of each path that are part of the overlapping interview.

In one embodiment, the constraint operator can represent the start point of modelling decision enforcement based on attribute values. This can be achieved in, in an exclusive-or block, there are clear differences between the attributes associated with every exclusive path. This capability answers the questions “how is this decision influenced by this attribute?”

Advantageously, embodiments described herein generated annotated exclusive outgoing paths of process models with a big-O complexity of polynomial. This may be achieved using helper functions that limit the entries, in accordance with the need of the exclusive-or block, by looking at the cases individually.

FIG. 10 is an architectural diagram illustrating a computing system 1000 configured to perform embodiments described herein. In some embodiments, computing system 1000 may be one or more of the computing systems depicted and/or described herein. Computing system 1000 includes a bus 1005 or other communication mechanism for communicating information, and processor(s) 1010 coupled to bus 1005 for processing information. Processor(s) 1010 may be any type of general or specific purpose processor, including a Central Processing Unit (CPU), an Application Specific Integrated Circuit (ASIC), a Field Programmable Gate Array (FPGA), a Graphics Processing Unit (GPU), multiple instances thereof, and/or any combination thereof. Processor(s) 1010 may also have multiple processing cores, and at least some of the cores may be configured to perform specific functions. Multi-parallel processing may be used in some embodiments. In certain embodiments, at least one of processor(s) 1010 may be a neuromorphic circuit that includes processing elements that mimic biological neurons. In some embodiments, neuromorphic circuits may not require the typical components of a Von Neumann computing architecture.

Computing system 1000 further includes a memory 1015 for storing information and instructions to be executed by processor(s) 1010. Memory 1015 can be comprised of any combination of random access memory (RAM), read-only memory (ROM), flash memory, cache, static storage such as a magnetic or optical disk, or any other types of non-transitory computer-readable media or combinations thereof. Non-transitory computer-readable media may be any available media that can be accessed by processor(s) 1010 and may include volatile media, non-volatile media, or both. The media may also be removable, non-removable, or both. Computing system 1000 includes a communication device 1020, such as a transceiver, to provide access to a communications network via a wireless and/or wired connection. In some embodiments, communication device 1020 may include one or more antennas that are singular, arrayed, phased, switched, beamforming, beamsteering, a combination thereof, and or any other antenna configuration without deviating from the scope of the invention.

Processor(s) 1010 are further coupled via bus 1005 to a display 1025. Any suitable display device and haptic I/O may be used without deviating from the scope of the invention.

A keyboard 1030 and a cursor control device 1035, such as a computer mouse, a touchpad, etc., are further coupled to bus 1005 to enable a user to interface with computing system 1000. However, in certain embodiments, a physical keyboard and mouse may not be present, and the user may interact with the device solely through display 1025 and/or a touchpad (not shown). Any type and combination of input devices may be used as a matter of design choice. In certain embodiments, no physical input device and/or display is present. For instance, the user may interact with computing system 1000 remotely via another computing system in communication therewith, or computing system 1000 may operate autonomously.

Memory 1015 stores software modules that provide functionality when executed by processor(s) 1010. The modules include an operating system 1040 for computing system 1000. The modules further include a constraint operator module 1045 that is configured to perform all or part of the processes described herein or derivatives thereof. Computing system 1000 may include one or more additional functional modules 1050 that include additional functionality.

One skilled in the art will appreciate that a “computing system” could be embodied as a server, an embedded computing system, a personal computer, a console, a personal digital assistant (PDA), a cell phone, a tablet computing device, a quantum computing system, or any other suitable computing device, or combination of devices without deviating from the scope of the invention. Presenting the above-described functions as being performed by a “system” is not intended to limit the scope of the present invention in any way, but is intended to provide one example of the many embodiments of the present invention. Indeed, methods, systems, and apparatuses disclosed herein may be implemented in localized and distributed forms consistent with computing technology, including cloud computing systems. The computing system could be part of or otherwise accessible by a local area network (LAN), a mobile communications network, a satellite communications network, the Internet, a public or private cloud, a hybrid cloud, a server farm, any combination thereof, etc. Any localized or distributed architecture may be used without deviating from the scope of the invention.

It should be noted that some of the system features described in this specification have been presented as modules, in order to more particularly emphasize their implementation independence. For example, a module may be implemented as a hardware circuit comprising custom very large scale integration (VLSI) circuits or gate arrays, off-the-shelf semiconductors such as logic chips, transistors, or other discrete components. A module may also be implemented in programmable hardware devices such as field programmable gate arrays, programmable array logic, programmable logic devices, graphics processing units, or the like.

A module may also be at least partially implemented in software for execution by various types of processors. An identified unit of executable code may, for instance, include one or more physical or logical blocks of computer instructions that may, for instance, be organized as an object, procedure, or function. Nevertheless, the executables of an identified module need not be physically located together, but may include disparate instructions stored in different locations that, when joined logically together, comprise the module and achieve the stated purpose for the module. Further, modules may be stored on a computer-readable medium, which may be, for instance, a hard disk drive, flash device, RAM, tape, and/or any other such non-transitory computer-readable medium used to store data without deviating from the scope of the invention.

Indeed, a module of executable code could be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices, and may exist, at least partially, merely as electronic signals on a system or network.

The process steps disclosed herein, such as, e.g., the process steps performed in FIG. 1, may be performed by a computer program, encoding instructions for the processor(s) to perform at least part of the process(es) in accordance with embodiments of the present invention. The computer program may be embodied on a non-transitory computer-readable medium. The computer-readable medium may be, but is not limited to, a hard disk drive, a flash device, RAM, a tape, and/or any other such medium or combination of media used to store data. The computer program may include encoded instructions for controlling processor(s) of a computing system (e.g., processor(s) 1010 of computing system 1000 of FIG. 10) to implement all or part of the process steps described in, e.g., FIG. 1, which may also be stored on the computer-readable medium.

The computer program can be implemented in hardware, software, or a hybrid implementation. The computer program can be composed of modules that are in operative communication with one another, and which are designed to pass information or instructions to display. The computer program can be configured to operate on a general purpose computer, an ASIC, or any other suitable device.

It will be readily understood that the components of various embodiments of the present invention, as generally described and illustrated in the figures herein, may be arranged and designed in a wide variety of different configurations. Thus, the detailed description of the embodiments of the present invention, as represented in the attached figures, is not intended to limit the scope of the invention as claimed, but is merely representative of selected embodiments of the invention.

The features, structures, or characteristics of the invention described throughout this specification may be combined in any suitable manner in one or more embodiments. For example, reference throughout this specification to “certain embodiments,” “some embodiments,” or similar language means that a particular feature, structure, or characteristic described in connection with the embodiment is included in at least one embodiment of the present invention. Thus, appearances of the phrases “in certain embodiments,” “in some embodiment,” “in other embodiments,” or similar language throughout this specification do not necessarily all refer to the same group of embodiments and the described features, structures, or characteristics may be combined in any suitable manner in one or more embodiments.

It should be noted that reference throughout this specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussion of the features and advantages, and similar language, throughout this specification may, but do not necessarily, refer to the same embodiment.

Furthermore, the described features, advantages, and characteristics of the invention may be combined in any suitable manner in one or more embodiments. One skilled in the relevant art will recognize that the invention can be practiced without one or more of the specific features or advantages of a particular embodiment. In other instances, additional features and advantages may be recognized in certain embodiments that may not be present in all embodiments of the invention.

One having ordinary skill in the art will readily understand that the invention as discussed above may be practiced with steps in a different order, and/or with hardware elements in configurations which are different than those which are disclosed. Therefore, although the invention has been described based upon these preferred embodiments, it would be apparent to those of skill in the art that certain modifications, variations, and alternative constructions would be apparent, while remaining within the spirit and scope of the invention. In order to determine the metes and bounds of the invention, therefore, reference should be made to the appended claims.

1. A computer-implemented method comprising:
receiving a process model representing execution of a process;
identifying exclusive-or blocks in the process model;
determining attribute data relating to an exclusive outgoing path from an exclusive-or node in each of the identified exclusive-or blocks;
annotating at least one of the exclusive-or node or the exclusive outgoing paths based on the attribute data; and
outputting the annotated at least one of the exclusive-or node or the exclusive outgoing paths.

2. The computer-implemented method of claim 1, wherein the attribute data comprises numerical statistics comprising one or more a mean, a median, a number of quantiles, or a probability density function for an attribute.

3. The computer-implemented method of claim 1, wherein the attribute data comprises categorical statistics comprising one or more of a mode or a probability mass function.

4. The computer-implemented method of claim 1, further comprising:
generating a decision tree for one or more of the attributes, the decision tree denoting a threshold value to split paths.

5. The computer-implemented method of claim 1, wherein outputting the annotated at least one of the exclusive-or node or the exclusive outgoing paths comprises:
displaying the process model with the annotated at least one of the exclusive-or node or the exclusive outgoing paths.

6. The computer-implemented method of claim 5, wherein displaying the process model with the annotated at least one of the exclusive-or node or the exclusive outgoing paths comprises:
receiving user input selecting the exclusive-or node or the exclusive outgoing paths; and
in response to receiving the user input, displaying the attribute data.

7. The computer-implemented method of claim 1, further comprising:
executing the process using one or more computing devices.

8. The computer-implemented method of claim 1, wherein the process is a robotic process automation (RPA) process executed by one or more RPA robots.

9. A system comprising:
a memory storing computer program instructions; and
at least one processor configured to execute the computer program instructions, the computer program instructions configured to cause the at least one processor to perform operations of:
receiving a process model representing execution of a process;
identifying exclusive-or blocks in the process model;
determining attribute data relating to an exclusive outgoing path from an exclusive-or node in each of the identified exclusive-or blocks;
annotating at least one of the exclusive-or node or the exclusive outgoing paths based on the attribute data; and
outputting the annotated at least one of the exclusive-or node or the exclusive outgoing paths.

10. The system of claim 9, wherein the attribute data comprises numerical statistics comprising one or more a mean, a median, a number of quantiles, or a probability density function for an attribute.

11. The system of claim 9, wherein the attribute data comprises categorical statistics comprising one or more of a mode or a probability mass function.

12. The system of claim 9, the operations further comprising:
generating a decision tree for one or more of the attributes, the decision tree denoting a threshold value to split paths.

13. The system of claim 9, wherein outputting the annotated at least one of the exclusive-or node or the exclusive outgoing paths comprises:
displaying the process model with the annotated at least one of the exclusive-or node or the exclusive outgoing paths.

14. A non-transitory computer-readable medium storing computer program instructions, the computer program instructions, when executed on at least one processor, cause the at least one processor to perform operations comprising:
receiving a process model representing execution of a process;
identifying exclusive-or blocks in the process model;
determining attribute data relating to an exclusive outgoing path from an exclusive-or node in each of the identified exclusive-or blocks;
annotating at least one of the exclusive-or node or the exclusive outgoing paths based on the attribute data; and
outputting the annotated at least one of the exclusive-or node or the exclusive outgoing paths.

15. The non-transitory computer-readable medium of claim 14, wherein the attribute data comprises numerical statistics comprising one or more a mean, a median, a number of quantiles, or a probability density function for an attribute.

16. The non-transitory computer-readable medium of claim 14, wherein the attribute data comprises categorical statistics comprising one or more of a mode or a probability mass function.

17. The non-transitory computer-readable medium of claim 14, wherein outputting the annotated at least one of the exclusive-or node or the exclusive outgoing paths comprises:
displaying the process model with the annotated at least one of the exclusive-or node or the exclusive outgoing paths.

18. The non-transitory computer-readable medium of claim 17, wherein displaying the process model with the annotated at least one of the exclusive-or node or the exclusive outgoing paths comprises:
receiving user input selecting the exclusive-or node or the exclusive outgoing paths; and
in response to receiving the user input, displaying the attribute data.

19. The non-transitory computer-readable medium of claim 14, further comprising:
executing the process using one or more computing devices.

20. The non-transitory computer-readable medium of claim 14, wherein the process is a robotic process automation (RPA) process executed by one or more RPA robots.
